(19) United States
(12) Patent Application Publication
(10) Pub. No.: US 2016/0157303 A1
(43) Pub. Date: Jun. 2, 2016

(54) HEATING DEVICE

(71) Applicant: BEHR-HELLA THERMOCONTROL GMBH, Lippstadt (DE)

(72) Inventors: Lars HEEPER, Paderborn (DE); Karsten MARQUAS, Arnsberg (Vosswinkel) (DE); Dirk NAGEL, Paderborn (DE); Matthias STALLEIN, Rietberg (DE); Michael STEINKAMP, Lippstadt (DE)

(73) Assignee: BEHR-HELLA THERMOCONTROL GMBH, Lippstadt (DE)

(21) Appl. No.: 14/899,185

(22) PCT Filed: Jun. 18, 2014
(86) PCT No.: PCT/EP2014/062900

§ 371 Date: Dec. 17, 2015

(30) Foreign Application Priority Data
Jun. 19, 2013 (DE) 10 2013 211 559.8

(51) Int. Cl. H05B 6/10; H05B 6/38

(52) U.S. Cl. CPC H05B 6/108; H05B 6/38

(57) ABSTRACT

The invention relates to a heating device comprising a housing having a fluid channel arranged therein with a fluid inlet and a fluid outlet, wherein an element generating an alternating magnetic field is provided in the housing, wherein, furthermore, at least one metallic panel heating element is provided, which is heatable by the alternating magnetic field, wherein the at least one panel heating element is arranged in the fluid channel, wherein the element generating the alternating magnetic field is formed by a coil shaped in hollow-cylindrical fashion, which coil is operable by an AC voltage, wherein the coil is separated in fluidtight fashion from the fluid channel.

### TECHNICAL FIELD

The invention relates to a heating device having a housing, with, arranged therein, a fluid passage having a fluid inlet and a fluid outlet, wherein an element generating an alternating magnetic field is provided in the housing, wherein furthermore there is provided at least one metallic area heating element which can be heated by means of the alternating magnetic field, wherein the at least one areal heating element is arranged in the fluid passage.

### PRIOR ART

Heating devices are known in the prior art. Thus, there are air-side heating devices which have what are termed PTC heating elements that are supplied with electric current and thereby heat up. The heat is transferred to the air flowing through via air-side fins that are in contact with the PTC elements. However, the construction of these heating, devices is fundamentally different to that required for liquid media.

Heating devices for liquid media are provided with a closed housing formed with a fluid passage having a fluid inlet and a fluid outlet, wherein a heating element, which is heated with a PTO element, projects into the housing.

These heating devices for liquid media have the disadvantage that the heat is generated in a different region than in the fluid passage through which flows the liquid medium which is to be heated. This means that delayed heating is achieved due to the transfer resistances present, which must be considered disadvantageous.

### PRESENTATION OF THE INVENTION, OBJECT, SOLUTION, ADVANTAGES

The present invention therefore has the object of providing a heating device which is designed to heat a fluid, wherein the fluid to be heated flows directly over the heated elements. In addition, the heating device should be of as simple a construction as possible and as cost-effective as possible.

The object of the present invention is achieved with a heating device having the features of claim 1.

One exemplary embodiment of the invention relates to a heating device having a housing with, arranged therein, a fluid passage having a fluid inlet and a fluid outlet, wherein an element generating an alternating magnetic field is provided in the housing, wherein furthermore there is provided at least one metallic areal heating element which can be heated by means of the alternating magnetic field, wherein the at least one areal heating element is arranged in the fluid passage, wherein the element generating the alternating magnetic field is formed by a hollow-cylindrical coil that can be operated with an AC voltage, the coil being separated from the fluid passage in a fluid-tight manner.

A fluid-tight separation between the coil and the fluid flowing through the heating device is particularly advantageous since it is thus possible to prevent a short circuit. In addition, the coil is thus not exposed to corrosive influences, which could lead to damage to the coil.

It is also to be preferred if the coil is arranged in a coil housing that can be inserted into the housing, the coil housing being thermally conductive.

A thermally conductive coil housing is advantageous since this promotes the transport of heat away from the coil toward the fluid, whereby it is possible to achieve more effective cooling of the coil and at the same time improved heating of the fluid.

It is further to be preferred if the coil housing is formed by a cylindrical hollow body, the cylindrical hollow body being formed in one piece or from two hollow-cylindrical elements of different diameters.

The coil housing is advantageously matched to the structural form of the coil and/or to the structural form of the rest of the heating device. This permits a compact structural form of the heating device.

It is also expedient if the coil is arranged in an interspace between the two hollow-cylindrical elements of different diameters.

This makes it possible for the coil to be positioned in a region through which the fluid is not made to flow.

It is moreover advantageous if a fluid can be made to flow over a radially inward-oriented lateral surface and/or a radially outward-oriented lateral surface of the coil housing.

Making the fluid flow directly over the coil housing is advantageous since it is thus possible for the heat of the coil to be carried away particularly well.

Furthermore, it is to be preferred if the housing can be closed in a fluid-tight manner at a first one of is axial end regions by a first cover and at a second one of its axial end regions by a second cover. This ensures a functional fluid circulation within the heating device.

It is also advantageous if the first cover has an annularly circumferential groove into which the coil housing can be inserted.

An annularly circumferential groove, which is formed after the coil housing, is advantageous since it forms receiving portion for the coil housing, whereby the coil housing can be securely positioned in the heating device.

It can also be advantageous if the coil housing and the first cover are made in one piece, wherein an electrical contact with the coil is integrated into the first cover.

A one-piece embodiment, for example from a common injection cast part, is particularly advantageous since the installation of the coil in the heating device is made substantially simpler. In addition, electrical contact with the coil can then be effected by means of a passage or region integrated into the cover, which increases the mechanical robustness of the electrical contact and moreover simplifies the installation.

Furthermore, it is to be preferred if the first cover and/or the second cover and/or the coil housing are made of a plastic, wherein the respective cover has shielding elements for shielding the alternating magnetc field.

Manufacturing the cover and/or the coil housing from plastic is particularly advantageous in order to achieve a production which is as cost-effective as possible. In the case of a cover made from plastic, this cover can contain shielding elements which limit an undesired propagation of the alternating magnetic field through the cover. This is necessary in order to reduce or entirely prevent negative effects of the alternating magnetic field on adjacent electric or metallic components. One possible shielding element could be a ferritic sheet which is attached to an internal surface an external surface of the cover.

Alternatively, such a ferritic sheet can also be cast into the cover.

According to a particularly advantageous refinement of the invention, it can be provided that the coil housing can be filled with a medium by means of which it is possible to seal the coil housing in a fluid-tight manner and/or to raise the thermal conductivity within the coil housing. This also serves to avoid short-circuits and to improve the thermal management of the heating device.

It is further expedient if the coil housing has, on at least one of its lateral surfaces past which a fluid can be made to flow, swirl elements and/or turbulence elements.

It is thus possible for the fluid flow within the heating device to be positively influenced. It is in particular possible to achieve better mixing of the fluid, which can lead to a more homogeneous temperature distribution within the heating device.

Furthermore, it is to be preferred if the coil housing and/or the coil has a temperature sensor. This is advantageous for determining the temperature of the coil, in order, where relevant, to be able to guard against an overload.

It is also advantageous if a temperature sensor is arranged in a region through which the fluid is made to flow. This is advantageous in order to be able to reliably detect the temperature of the fluid.

Furthermore, it can be particularly advantageous if the hydraulic diameter of at least one region through which the fluid is made to flow can be changed by introducing a displacement body.

It is thus possible for the throughflow of the heating device to be optimized, which can contribute to greater service capability of the heating device.

It is also advantageous if a fluid can be made to flow against one or both sides of the areal heating element.

The areal heating element is preferably in direct contact with the fluid flowing through the fluid passage. Proper and rapid heating of the fluid is thereby achieved.

Furthermore, it can be particularly advantageous if a fluid is made to flow against both sides of the areal heating element, with the flow direction of the fluid on one side of the areal heating element being the same as or opposite to the flow direction on the other side of the areal heating element. Thus, the fluid is guided in sequence first past one side and then past the other side of the areal heating element. This increases the effectiveness of the heating.

A preferred exemplary embodiment is characterized in that the element generating an alternating magnetic field is an essentially hollow-cylindrical element.

It is also to be preferred if the areal heating element is an essentially hollow-cylindrical element.

It is further to be preferred if the element generating an alternating magnetic field is a hollow-cylindrical element, at least one areal heating element being arranged radially inside and/or outside the hollow-cylindrical element generating the alternating magnetic field. This creates a compact heating device.

It is also to be preferred if one or more hollow-cylindrical areal heating elements are arranged radially inside and/or outside the hollow-cylindrical element generating the alternating magnetic field. The thermal output can thereby also be increased.

Furthermore, it can be provided that the element generating an alternating magnetic field is an essentially hollow-cylindrical coil.

It is also advantageous if the control unit is connected to the housing or is integrated into the latter.

Furthermore, it can be advantageous if the housing is made of a material which absorbs magnetic fields or is opaque to alternating magnetic fields.

Moreover, it is expedient if the wall is made of a material which is transparent to magnetic fields.

Advantageous refinements of the present invention are described in the subclaims and in the following description of the figures.

### BRIEF DESCRIPTION OF THE DRAWINGS

The invention will be explained in detail below on the basis of exemplary embodiments and with reference to the drawings, in which:

FIG. 1 is a perspective view of a heating device having an integrated control unit,

FIG. 2 is a sectional view of the heating device as shown in FIG. 1, and

FIG. 3 is an exploded view of the heating device as shown in FIGS. 1 and 2.

### PREFERRED EMBODIMENT OF THE INVENTION

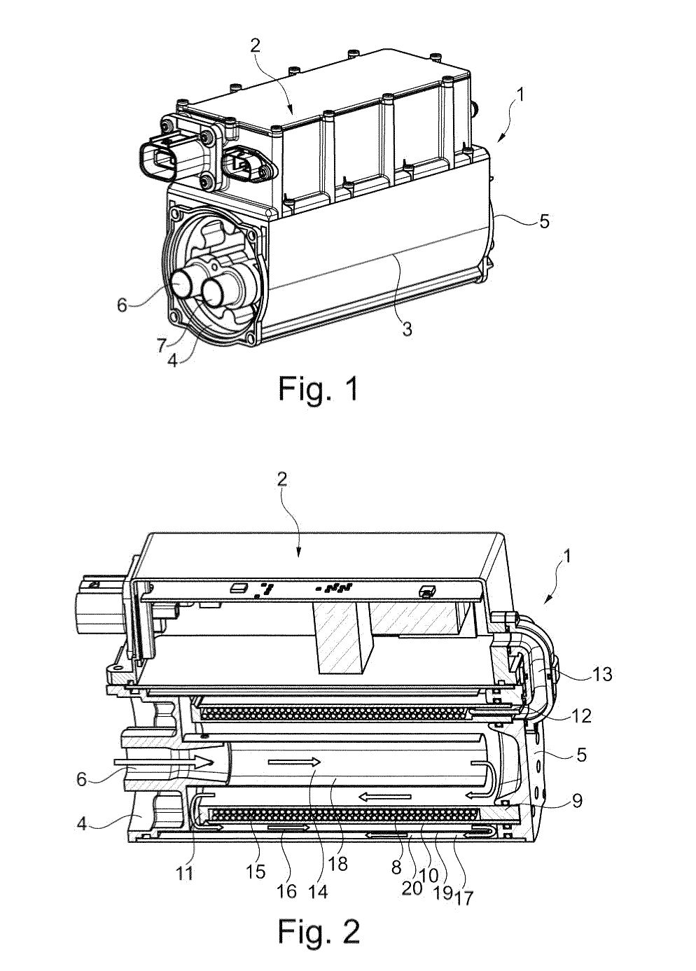

FIG. 1 shows a perspective view of a heating device 1. The heating device 1 has a housing 3 to which there is connected a control unit 2. In that context, the control unit 2 is for example attached Lo the housing 3 by means of screw connections. The housing 3 forms a cylindrical internal space in which are integrated the components of the heating device 1. Covers 4, 5 are provided at the axial end regions of the housing 3 and close the housing 3 at its ends. The cover 4 has a fluid connection 6 and a fluid connection 7 which, depending on the flow direction within the heating device 1, can be used respectively as fluid inlet and/or fluid outlet.

FIG. 2 shows a sectional view through the heating device 1 shown in FIG. 1. The upper region of FIG. 2 shows the control unit 2 which will not be discussed in more detail in the following.

A coil housing 9, which is formed from two cylindrical hollow bodies 10, 11, is arranged inside the housing 3. A coil 8 is arranged within the coil housing 9. This coil 8 forms a hollow-cylindrical body which consists of a winding of electrically coductive material.

The coil 8 is connected to the control unit 2 via an electrical contact 12. To that end, there is provided, outside the housing 3, a connection region 13 through which the electrical contact 12 can be guided into the control unit 2.

The coil housing 9, which is formed by the two cylindrical hollow bodies 10, 11, can have internally, in addition to the coil 9, a medium which on one hand encloses the coil 8 in a fluid-tight manner within the coil housing 9 and on the other hand increases the thermal conductivity within the coil housing 9.

The two cylindrical hollow bodies 10, 11 have different diameters such that inserting one of the two cylindrical hollow bodies 10, 11 into the other results in a cavity between the cylindrical hollow bodies 10, 11, which cavity forms the receiving region for the coil 8.

A pipe 18, which forms a passage 14 through which a fluid can flow, is arranged at the center of the coil housing 9. The passage 14 is then in direct fluidic communication with the fluid connection 6.

In FIG. 2, the fluid connection 6 is in the form of a fluid inlet. A fluid can accordingly flow through the fluid connection 6 along the passage 14 in the pipe 18 and, at that end region of the pipe 18 oriented away from the fluid connection 6, flow into a region within the cylindrical hollow body 11 of the coil housing 9.

In that context, the pipe 18 is plugged onto a shoulder affixed to the inside of the cover 4 or to the fluid connection 6, where it is connected thereto. That end region of the pipe 18 oriented away from the fluid connection 6 is spaced apart from the cover 5 such that there results, between the pipe 18 and the cover 5, an air gap through which a fluid can flow into the passage 15 formed between the pipe 18 and the cylindrical hollow body 11. The fluid then flows through the passage 15 toward the cover 4. Between the coil housing 9 and the cover 4, there is provided an air gap through which the fluid can finally overflow into a passage formed between the coil housing and an areal heating element 19, which is also formed as a hollow-cylindrical body.

The fluid can then flow back in the direction of the cover 5. Between the areal heating element 19 and the cover 5, there is also provided an air gap by means of which the fluid can once again be diverted and can flow between the areal heating element 19 and a housing wall of the housing 3 back in the direction of the cover 4. A further areal heating element 20 can be provided between the areal heating element 19 and the housing wall. In that context, this areal heating element 20 divides the passage 17, between the areal heating element 19 and the housing wall of the housing 3, into part passages.

Via radial openings in the cover 4, the fluid can finally flow out of the heating device 1 via the fluid connection 7 (not shown in FIG. 2).

The coil housing 9 is arranged in the heating device such that a fluid can be made to flow around both of its sides. It is thus possible for the resulting heat within the coil 8 to be carried away by the fluid and in addition a heating effect for the fluid can be produced.

On those external surfaces of the coil housing 9 which are oriented toward the fluid, it is advantageously possible to provide surface-increasing elements such as for example swirl elements or turbulence elements. It is thus possible for the flow of a fluid to be positively influenced so as to improve a transfer of heat between the areal heating elements within the heating device 1 and the fluid.

The elements shown in the heating device 1, such as the pipe 18, the areal heating element 19 or the areal heating element 20, which are made of a metallic material, can be heated on the basis of an induction effect. The heat can then be transferred to the fluid flowing around the elements, thus heating the fluid.

The coil 8 is preferably provided, via the electrical contacts 12, with a current source which transmits an AC voltage to the coil 8. It is thus possible to generate an alternating magnetic field which can lead to heating of the metallic elements such as for example the pipe 18 and the areal heating elements 19 and 20.

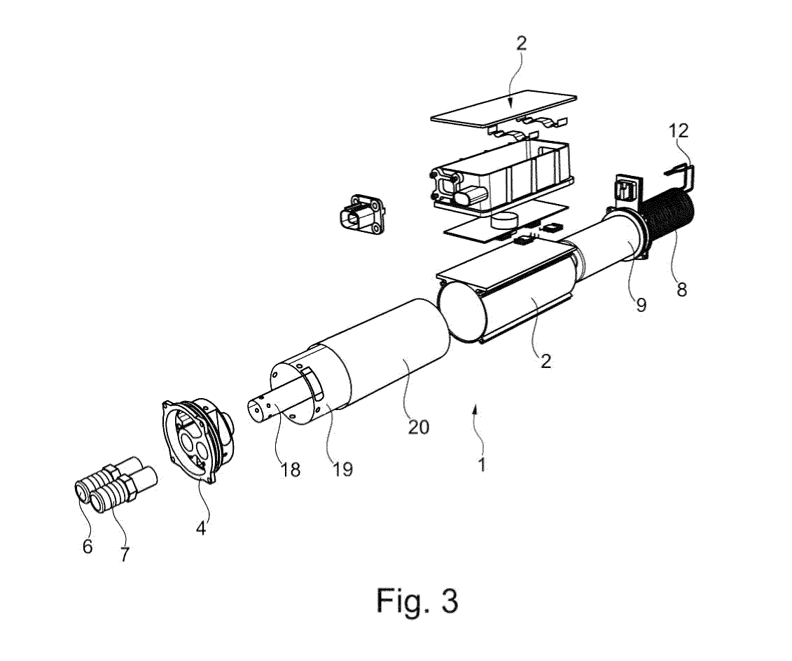

FIG. 3 shows an exploded view of the heating device 1 as has already been shown in FIGS. 1 and 2. FIG. 3 shows in particular how individual elements of the heating device 1 are arranged within one another. Thus, the fluid connections 6 and, respectively, 7 can be inserted into openings in the cover 4 and can be inserted, with the pipe 18 and, respectively, the areal heating element 19 and an areal heating element 20, into the housing 2. The coil housing 9 and the coil 8 with its electrical contacts 12 can be inserted into the housing 2 so to speak from the opposite side. The control unit 2, which is provided for controlling the coil 8, is provided on the upper side of the housing 3.

By virtue of the design of the coil housing 9, it is possible for the coil 8 to be entirely separated from the fluid flowing through the heating device 1. This makes it possible to avoid an electrical short circuit. Moreover, the integration of the coil A and the coil housing 9, around which fluid is made to flow, permits an advantageous transfer of heat from the coil to the fluid.

The exemplary embodiments shown in FIGS. 1 to 3 are exemplary. In particular with respect to the dimensions of the elements, the geometric design of the individual elements and/or the arrangement of the elements with respect to one another, FIGS. 1 to 3 do not have any limiting character. The individual features of the various exemplary embodiments can be combined with one another.

1. A heating device having a housing with, arranged therein, a fluid passage having a fluid inlet and a fluid outlet, wherein an element generating an alternating magnetic field is provided in the housing, wherein furthermore there is provided at least one metallic areal heating element which can be heated by means of the alternating magnetic field, wherein the at least one areal heating element is arranged in the fluid passage, wherein the element generating the alternating magnetic field is formed by a hollow-cylindrical coil that can be operated with an AC voltage, the coil being separated from the fluid passage in a fluid-tight manner.

2. The heating device as claimed in claim 1, wherein the coil is arranged in a coil housing that can be inserted into the housing, the coil housing being thermally conductive.

3. The heating device as claimed in claim 1, wherein the coil housing is formed by a cylindrical hollow body, the cylindrical hollow body being formed in one piece or from two hollow-cylindrical elements of different diameters.

4. The heating device as claimed in claim 3, wherein the coil is arranged in an interspace between the two hollow-cylindrical elements of different diameters.

5. The heating device as claimed in claim 1, wherein a fluid can be made to flow over a radially inward-oriented lateral surface and/or a radially outward-oriented lateral surface of the coil housing.

6. The heating device as claimed in one claim 1, wherein the housing can be closed in a fluid-tight manner at a first one of its axial end regions by a first cover and at a second one of its axial end regions by a second cover.

7. The heating device as claimed in claim 6, wherein the first cover has an annularly circumferential groove into which the coil housing can be inserted.

8. The heating device as claimed in claim 6, wherein the coil housing and the first cover are made in one piece, wherein an electrical contact with the coil is integrated into the first cover.

9. The heating device as claimed in claim 1, wherein the first cover and/or the second cover and/or the coil housing are made of a plastic, wherein the respective cover has shielding elements for shielding the alternating magnetic field.

10. The heating device as claimed in claim 1, wherein t the coil housing can be filled with a medium by means of which it is possible to seal the coil housing in a fluid-tight manner and/or to raise the thermal conductivity within the coil housing.

11. The heating device as claimed in claim 1, wherein the coil housing has, on at least one of its lateral surfaces past which a fluid can be made to flow, swirl elements and/or turbulence elements.

12. The heating device as claimed in claim 1, wherein the coil housing and/or the coil has a temperature sensor.

13. The heating device as claimed in claim 1, wherein a temperature sensor is arranged in a region through which the fluid is made to flow.

14. The heating device as claimed in claim 1, wherein the hydraulic diameter of at least one region through which the fluid is made to flow can be changed by introducing a displacement body.
